(19) United States
(12) Patent Application Publication
(10) Pub. No.: US 2013/0231841 A1
(43) Pub. Date: Sep. 5, 2013

(54) SYSTEM AND METHOD FOR REPORTING ENERGY EFFICIENCY RECOMMENDATIONS FOR A VEHICLE TO A REQUESTING USER

(71) Applicant: Leigh M. Rothschild, Sunny Isles Beach, FL (US)

(72) Inventor: Leigh M. Rothschild, Sunny Isles Beach, FL (US)

(73) Assignee: ARIEL INVENTIONS LLC, Sunny Isles Beach, FL (US)

(21) Appl. No.: 13/860,514

(22) Filed: Apr. 10, 2013

Related U.S. Application Data
(63) Continuation of application No. 13/369,981, filed on Feb. 9, 2012, now abandoned.

(51) Int. Cl. G06F 17/00

(52) U.S. Cl. CPC G06F 17/00
USPC 701/99; 701/1; 701/118

(57) ABSTRACT

Embodiments of the present invention provide a method and system for providing a vehicle operation energy efficiency recommendation. In accordance with an embodiment of the present invention, vehicle sensor data is accessed. The vehicle sensor data is analyzed. A vehicle operation energy efficiency recommendation is generated based at least in part on the analyzed vehicle sensor data.

### CROSS-REFERENCE TO RELATED APPLICATION

This application is related to and claims priority to U.S. Non-Provisional Patent Application Ser. No. 13/369, 981 filed Feb. 9, 2012, entitled SYSTEM AND METHOD FOR REPORTING ENERGY EFFICIENCY RECOMMENDATIONS FOR A VEHICLE TO A REQUESTING USER, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for route navigation based on energy efficiency.

### BACKGROUND OF THE INVENTION

The burning of fossil fuels to generate energy produces carbon dioxide, the primary contributor to environmental pollution. Pollution introduces contaminants into the natural environment causing harm to our ecosystem. Hence, it is desirable to reduce the demand for energy, which will reduce the burning of fossil fuels, such as coal, oil and natural gas. One way to diminish energy consumption is to increase the energy efficiency of vehicles, as fuel combustion produces harmful chemicals that are released as exhaust.

The energy consumed by a vehicle can be reduced by driving in a manner that is energy efficient. For example, the energy consumed by the vehicle can be reduced by proper maintenance and replacement of worn parts. Currently, there is no easy way of determining how a driver can operate the vehicle in an energy efficient manner. As a result, there is also no easy way to provide this information to a driver.

What is needed is a method and system for providing recommendations to drivers for energy efficient vehicle operation and providing the recommendations in various formats.

### SUMMARY OF THE INVENTION

The present invention advantageously provides a method and system for providing vehicle operation energy efficiency recommendation for a vehicle. In accordance with one aspect, the invention provides a method that includes accessing vehicle sensor data. The vehicle sensor data is analyzed. A vehicle operation energy efficiency recommendation is generated based at least in part on the analyzed vehicle sensor data. In an exemplary embodiment, the generated energy efficiency recommendation is displayed. The energy efficiency recommendation may be displayed on a vehicle display, a computer, a wireless mobile device, among other devices.

In accordance with another aspect, the invention provides a system that includes a device having a processor. The processor accesses vehicle sensor data. The processor analyzes the vehicle sensor data. The processor generates a vehicle operation energy efficiency recommendation based at least in part on the analyzed vehicle sensor data

According to another aspect, the present invention provides a computer readable medium storing computer readable instructions that when executed by a processor, cause the processor to access vehicle sensor data. The processor further analyzes the vehicle sensor data. The processor generates a vehicle operation energy efficiency recommendation based at least in part on the analyzed vehicle sensor data.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of a system constructed in accordance with the principles of the present invention;

FIG. 2 is a block diagram of an exemplary device constructed in accordance with the principles of the present invention;

FIG. 3 is a block diagram of an exemplary database according to the principles of the present invention;

FIG. 4 is a block diagram of an exemplary server constructed in accordance with the principles of the present invention; and

FIG. 5 is a flow chart of an exemplary process for generating a vehicle operation energy efficiency recommendation, in accordance with the principles of the present invention.

### DETAILED DESCRIPTION OF THE INVENTION

Embodiments of the present invention provide a method and system for generating an energy efficiency recommendation to improve an energy efficiency of a vehicle. In accordance with an embodiment of the present invention, vehicle sensor data is accessed and analyzed. A vehicle operation energy efficiency recommendation is generated based at least in part on the analyzed vehicle sensor data.

Before describing in detail exemplary embodiments that are in accordance with the present invention, it is noted that the embodiments reside primarily in combinations of apparatus components and processing steps related to implementing a method and system for generating a vehicle operation energy efficiency recommendation based at least in part on analyzed vehicle sensor data. Accordingly, the method and system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

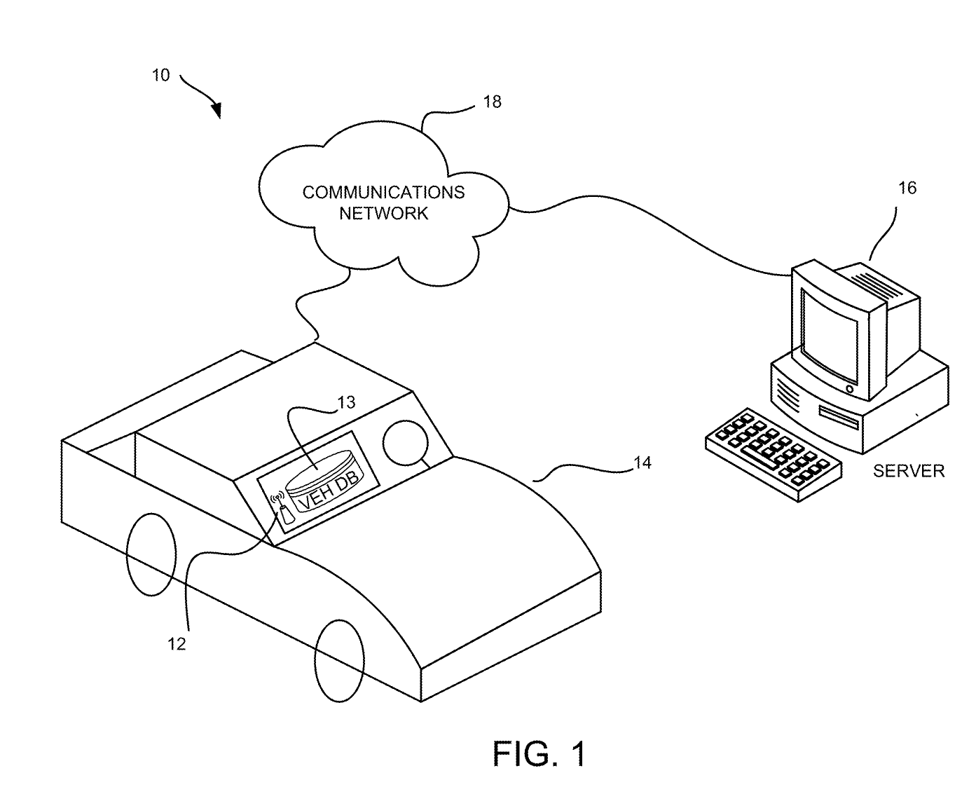

Referring now to the drawing figures in which reference designators refer to like elements, there is shown in FIG. 1 a schematic illustration of a system in accordance with the principles of the present invention, and generally designated as “10”. As shown in FIG. 1, a device 12 may include vehicle information database 13. Device 12 may be positionable on vehicle 14. Device 12 may be a vehicle navigation system, a portable navigation system, a vehicle computer, mobile device, personal computer, laptop computer, tablet computer, PDA, among other types of computing devices. A driver of vehicle 14 may wish to determine an energy efficiency recommendation for vehicle 14. Device 12 may access and analyze vehicle sensor data. Device 12 may generate a vehicle operation energy efficiency recommendation based at least in part on the analyzed vehicle sensor data. Device 12 may also generate the vehicle operation energy efficiency recommendation based at least in part on other data, such as a driver's driving style, road data, vehicle location, vehicle data, vehicle maintenance schedule, etc. among other data.

Device 12 may be in communication with server 16 via communication network 18. Communication network 18 may include a cellular communication network and the Public Switched Telephone Network (PSTN), or other wide area network (WAN), such as the Internet, as well as local area networks (LANs), such as an Ethernet LAN. Communications network 18 may be a wireless network, such as Wi-Fi, satellite, infrared, Bluetooth, Near Field Communications, or other communications network. Device 12 and server 16 may be connected via communications network 18 to other computers, such as computers associated with a car manufacturer, a weather service or any other third party (not shown).

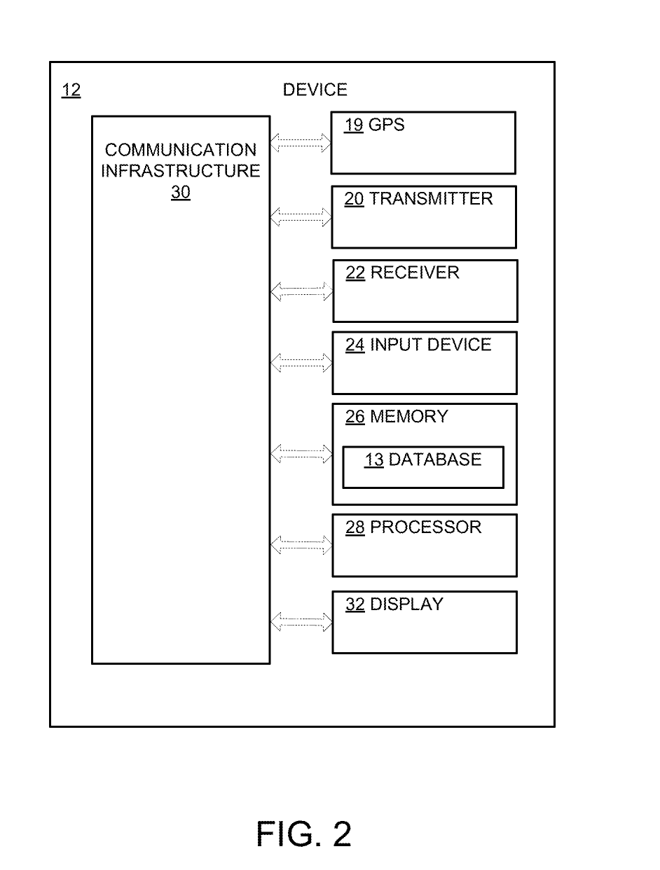

FIG. 2 is a block diagram of an exemplary device 12 constructed in accordance with the principles of the present invention. Device 12 may include global positioning system unit (“GPS”) 19, transmitter 20, receiver 22, input device 24, memory 26, processor 28 and display 32, all connected via communication infrastructure 30. Processor 28 may include a central processing unit (CPU) for performing device 12 functionality. Processor 28 is operatively coupled to a communication infrastructure 30, e.g., a communications bus, cross-bar interconnect, network, etc. Input device 24 may be a keyboard, a key pad or a touch pad. Device 12 may use transmitter 20 and receiver 22 for communicating with server 16 via communications network 18 wirelessly or by wire or optical fiber. Memory 26 may include random access memory (“RAM”) and read only memory (“ROM”). Memory 26 may store vehicle information database 13. Computer programs (also called computer control logic) may be stored in memory 26. For example, computer programs are stored on memory 26 for execution by processor 28 via RAM, i.e. memory 26. Such computer programs, when executed, enable the method and system to perform the features of the present invention as discussed herein. In particular, the computer programs, when executed, enable processor 28 to perform the features of the corresponding method and system. Accordingly, such computer programs represent controllers of the corresponding device.

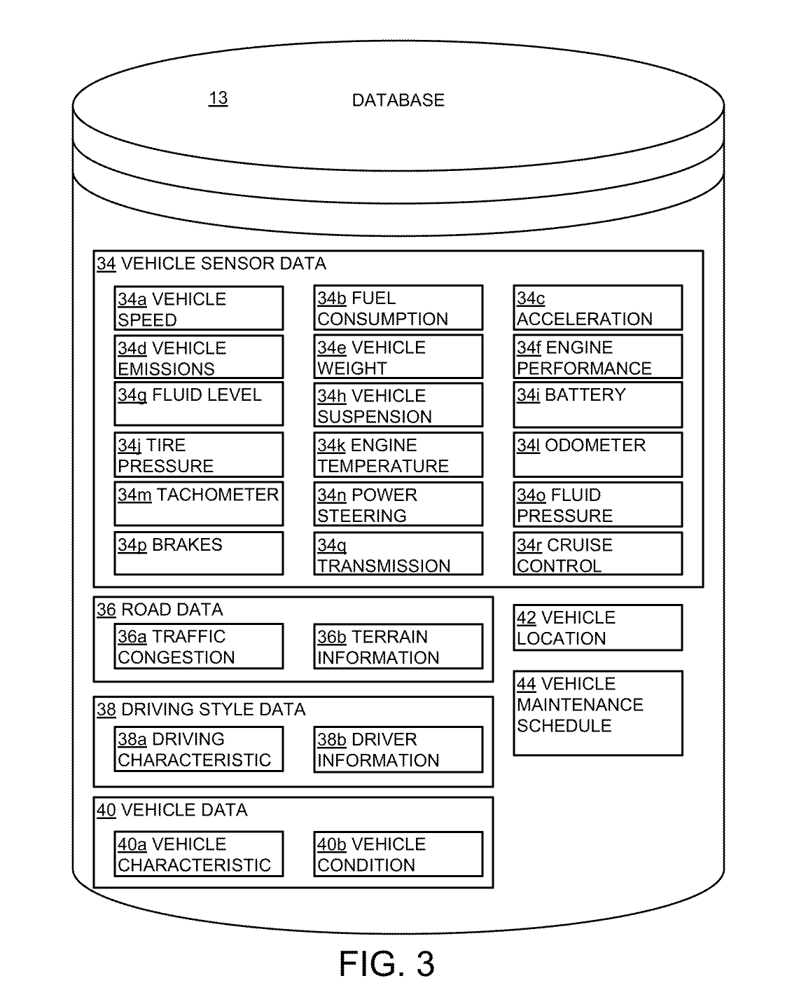

FIG. 3 is a block diagram of an exemplary vehicle information database 13 constructed in accordance with the principles of the present invention. Vehicle information database 13 may include vehicle sensor data 34 for at least one sensor in vehicle 14. Vehicle sensor data 34 may include, but is not limited to, vehicle speed data 34a, fuel consumption data 34b, acceleration data 34c, vehicle emissions data 34d, vehicle weight data 34e, engine performance data 34f, fluid level data 34g, vehicle suspension data 34h, battery data 34i, tire pressure data 34j, engine temperature data 34k, odometer data 34l, tachometer data 34m, power steering data 34n, fluid pressure data 34o, brakes data 34p, transmission data 34q, and cruise control data 34r.

Vehicle information database 13 may also include other data that may be used by device 12 to generate a vehicle operation energy efficiency recommendation. Other data may include, but is not limited to, road data 36, driving style data 38, vehicle data 40, vehicle location information 42 and vehicle maintenance schedule 44. Road data 36 may include, but is not limited to, traffic congestion information 36a and terrain information 36b. Driving style data 38 may include, but is not limited to—at least one driving characteristic 38a and driver information 38b. Vehicle data 40 may include, but is not limited to—at least one vehicle characteristic 40a and vehicle condition 40b. Of note, although vehicle sensor data 34, road data 36, driving style data 38, vehicle data 40, vehicle location 42 and vehicle maintenance schedule information 44 are described herein as being stored in a “database,” the invention is not limited to—storage in a formal database management system, e.g., SQL. It is contemplated that any memory storage device can store vehicle sensor data 34 in an organized and retrievable form, e.g. flat file.

Vehicle speed data 34a may include, but is not limited to, information about the speed of vehicle 14. Fuel consumption data 34b may include, but is not limited to, information about fuel consumption of vehicle 14, such as city and highway fuel consumption, i.e., an energy consumption rate of vehicle 14. Acceleration data 34c may include, but is not limited to, information about the acceleration of vehicle 14. Vehicle emissions data 34d may include information about emissions emanating from vehicle 14. For example, vehicle emissions data 34 may include the amount of hydrocarbons, carbon monoxide, nitrogen oxides, sulfur oxide and volatile organic compounds emanating from vehicle 14. Vehicle weight data 34e may include, but is not limited to, information about the weight of vehicle 14 and whether vehicle 14 is pulling a load. Engine performance data 34f may include, but is not limited to, information about a performance of an engine of vehicle 14, a power output of vehicle 14, information about a fuel and air mixture in an engine of vehicle 14, spark plug performance, etc.

Fluid level data 34g may include, but is not limited to, information about the fluid level of vehicle fluids such as transmission fluid, brake fluid, oil fluid, radiator fluid, battery fluid, window washer fluid, etc. Vehicle suspension data 34h may include, but is not limited to, information relating to the springs, shock absorbers, suspension and linkages of vehicle 14. Battery data 34i may include, but is not limited to, information about a battery of vehicle 14, such as the charge of the battery and the condition of the battery conductors. Tire pressure data 34j may include, but is not limited to, information about the air pressure in a tire of vehicle 14. Engine temperature data 34k may include, but is not limited to, information about a temperature of an engine of vehicle 14. Odometer data 341 may include odometer information, and tachometer data 34m may include tachometer data associated with vehicle 14.

Power steering data 34n may include, but is not limited to, information about a power steering mechanism of vehicle 14 and about the hydraulic or electric actuators of the power steering mechanism. Fluid pressure data 34o may include, but is not limited to, information about the pressure of fluids in vehicle 14, such as the pressure of the transmission fluid and the brake fluid. Brake data 34p may include, but is not limited to, information about the condition of the brakes of vehicle 14. Transmission data 34q may include, but is not limited to, information about the transmission of vehicle 14, such as whether vehicle 14 has an automatic transmission or a manual transmission. Additionally, transmission data 34q may include, but is not limited to, information about the condition of the transmission of vehicle 14 and the RPMs associated with each transmission level. Cruise control data 34r may include, but is not limited to, information on the cruise control mechanism of vehicle 14.

Traffic congestion information 36a may include information associated with traffic conditions of a route, including but not limited to an average speed of vehicles travelling on the route, accidents along the route, a speed limit, closed roads, and construction along the route.

For example, a route that includes a large number of traffic stops may cause vehicle 14 to consume more energy than a route with fewer traffic stops.

Terrain information 36b may include geospatial and topographic information associated with a route. Terrain information 36b may also include, but is not limited to, information associated with a route's roads, such as an elevation of the roads, road conditions, road temperature, road slope, and road contours. Additionally, terrain information 36b may include, for example, weather information such as actual and/or predicted weather conditions, such as whether there is snow or ice on the roads, whether it is raining on the road, a wind speed, a direction of the wind, or whether there is a weather hazard, such as a tornado warning. For example, a route that includes roads that are covered with ice may cause vehicle 14 to consume more energy than a route that does not include icy roads. Terrain information 36b may also include information about the types of roads that a vehicle will encounter when travelling on the route, such as whether the route includes rural roads with shallow curves, suburban roads or urban roads that require frequent stops. Terrain information 36b may be obtained in real time from geostationary satellites.

Driving characteristic 38a may include, but is not limited to, at least one of an age, gender, reaction time, visual capability, speeding habits and traffic citations/accidents associated with a driver. Additionally, driving characteristics 38a may also include whether the driver is a risky driver that frequently change lanes, passes other vehicles, tailgates, honks and out-maneuvers other vehicles. For example, aggressive driving practices may cause vehicle 14 to consume more energy, given the constant braking and accelerating associated with aggressive driving. Device 12 may monitor a driver's driving style and store at least one driving characteristic 38a associated with the way a driver drives in vehicle information database 13.

Driving characteristics 38a may be configured and customized by a driver of vehicle 14. Driving characteristics 38a may be stored in a driving profile for each driver of vehicle 14.

Driver information 38b may include a driver's preference(s) or requirement(s) for a route considered in addition to the energy consumption. Driver information 38b may include input received from a driver. Driver information 38b may include the purpose of a trip, such as business or pleasure. For example, a driver may wish to take the route that takes the shortest amount of time to the destination location if on a hurry, or may wish to take a scenery route if the driver is on vacation. Driver information 38b may include, but is not limited to, a desired travel time, a scenery, travel purpose, desired stops along the way, rest stop availability, etc. The driver may further specify a type of scenery road desired for the trip, such as a scenery road that includes lakes, mountains, valleys, orchards, farms, small towns, historic places, or national parks. For example, if the trip is part of a family vacation, the energy efficiency recommendation may be to take a route that includes theme parks and family entertainment centers, but avoids heavy traffic.

Vehicle characteristic 40a may include, but is not limited to, a vehicle type, the make and model of vehicle 14 and the shape of vehicle 14. For example, vehicle's 14 shape and weight may affect the aerodynamic drag of vehicle 14, causing an increase of the estimated amount of energy needed to travel to a destination. Vehicle type may include, but is not limited to, a pickup truck, a station wagon, a coupe, a sedan, a sport car, a van, a minivan, a sport utility vehicle, a motorcycle, a truck, a boat and an airplane. For example, an energy efficiency recommendation for a large and heavy truck may be different than for a light and compact car. Vehicle condition 40b may include the condition of vehicle 14. For example, vehicle 14 may be in very good condition if it has been properly maintained. Vehicle location 42 may include, but is not limited to, information about the geographic location of vehicle 14. An energy efficiency recommendation may be different for a vehicle located in a high altitude country area than for a vehicle that will be driven in a city. Vehicle maintenance schedule 44 may include information about maintenance performed on vehicle 14, such as for example, the last time the oil and the transmission fluid were changed.

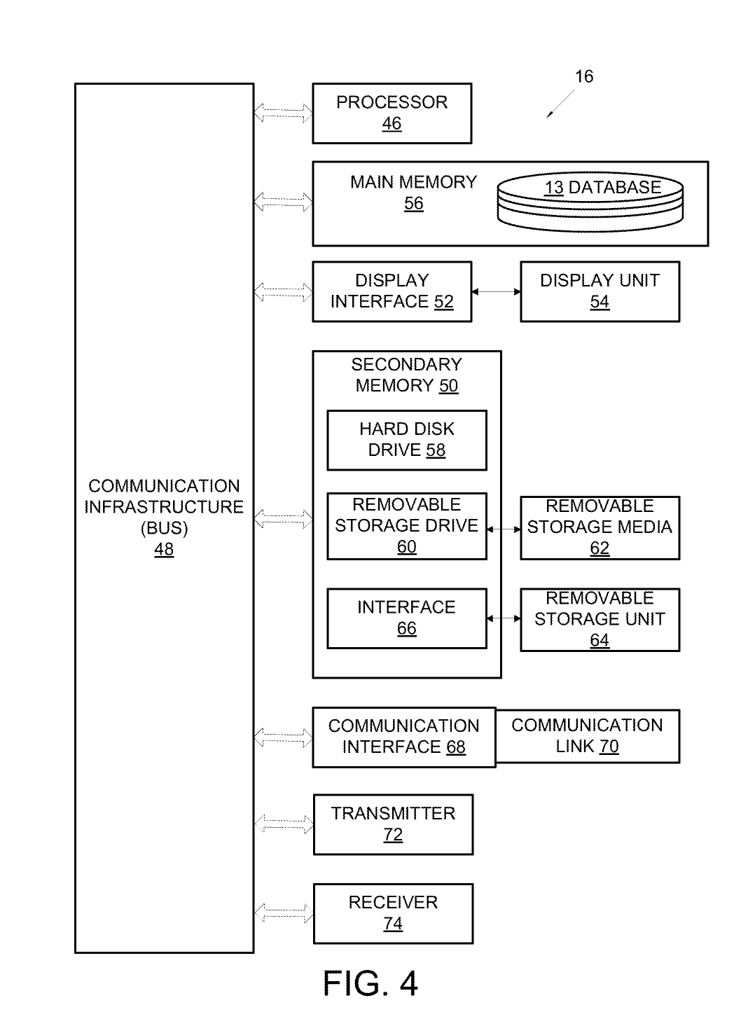

FIG. 4 is a block diagram of an exemplary server 16 constructed in accordance with the principles of the present invention. Server 16 includes one or more processors, such as processor 46 programmed to perform the functions described herein. Processor 46 is operatively coupled to a communication infrastructure 48, e.g., a communications bus, cross-bar interconnect, network, etc. Processor 46 may execute computer programs stored on disk storage for execution via secondary memory 50. Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of server 16 may be designed to occur remotely by web browser. In such case, the inclusion of a display interface and display unit may not be required.

Server 16 may optionally include or share a display interface 52 that forwards graphics, text, and other data from the communication infrastructure 48 (or from a frame buffer not shown) for display on the display unit 54. Display 54 may be a cathode ray tube (CRT) display, liquid crystal display (LCD), light-emitting diode (LED) display, organic light-emitting diode (OLED) display, and touch screen display, among other types of displays. The computer system also includes a main memory 56, such as random access memory (“RAM”) and read only memory (“ROM”), and may also include secondary memory 50. Main memory 56 may store vehicle information database 13.

Secondary memory 50 may include, for example, a hard disk drive 58 and/or a removable storage drive 60, representing a removable hard disk drive, magnetic tape drive, an optical disk drive, a memory stick, etc. The removable storage drive 60 reads from and/or writes to a removable storage media 62 in a manner well known to those having ordinary skill in the art. Removable storage media 62, represents, for example, a floppy disk, external hard disk, magnetic tape, USB flash drive, optical disk, etc. which is read by and written to by removable storage drive 60. As will be appreciated, the removable storage media 62 includes a computer usable storage medium having stored therein computer software and/or data.

In alternative embodiments, secondary memory 50 may include other similar devices for allowing computer programs or other instructions to be loaded into the computer system and for storing data. Such devices may include, for example, a removable storage unit 64 and an interface 66. Examples of such may include a program cartridge and cartridge interface (such as that found in video game devices), flash memory, a removable memory chip (such as an EPROM, EEPROM or PROM) and associated socket, and other removable storage units 64 and interfaces 66 which allow software and data to be transferred from the removable storage unit 64 to other devices.

Server 16 may also include a communications interface 68. Communications interface 68 allows software and data to be transferred to external devices. Examples of communications interface 68 may include a modem, a network interface (such as an Ethernet card), a communications port, a PCMCIA slot and card, wireless transceiver/antenna, etc. Software and data transferred via communications interface/module 68 may be, for example, electronic, electromagnetic, optical, or other signals capable of being received by communications interface 68. These signals are provided to communications interface 68 via the communications link (i.e., channel) 70. Channel 70 carries signals and may be implemented using wire or cable, fiber optics, a phone line, a cellular phone link, an RF link, and/or other communications channels.

It is understood that server 16 may have more than one set of communication interface 68 and communication link 70. For example, server 16 may have a communication interface 68/communication link 70 pair to establish a communication zone for wireless communication, a second communication interface 68/communication link 70 pair for low speed, e.g., WLAN, wireless communication, another communication interface 68/communication link 70 pair for communication with low speed wireless networks, and still another communication interface 68/communication link 70 pair for other communication.

Computer programs (also called computer control logic) are stored in main memory 56 and/or secondary memory 50. For example, computer programs are stored on disk storage, i.e. secondary memory 50, for execution by processor 46 via RAM, i.e. main memory 56. Computer programs may also be received via communications interface 68. Such computer programs, when executed, enable the method and system to perform the features of the present invention as discussed herein. In particular, the computer programs, when executed, enable processor 46 to perform the features of the corresponding method and system. Accordingly, such computer programs represent controllers of the corresponding device. Server 16 also includes transmitter 72 and receiver 74. Processor 46 communicates with transmitter 72 and receiver 74 via communication infrastructure 48. Server 16 may communicate with device 12 via communications network 18.

In an exemplary embodiment, server 16 may generate a vehicle operation energy efficiency recommendation based on a request received from device 12 a vehicle operation energy efficiency recommendation. Input device 24 may be used to enter a vehicle operation energy efficiency recommendation request. Transmitter 20 may transmit the request to server 16 via communications network 18. Receiver 74 of server 16 may receive the request. Processor 46 may query vehicle information database 13 in main memory 56 to access and retrieve at least one of vehicle sensor data 34, road data 36, driving style data 38, vehicle data 40, vehicle location 42 and vehicle maintenance schedule data 44 for use in generating the vehicle operation energy efficiency recommendation. Alternatively, device 12 may send, along with the request, at least one of vehicle sensor data 34, road data 36, driving style data 38, vehicle data 40, vehicle location 42 and vehicle maintenance schedule data 44 for use by the server in generating the vehicle operation energy efficiency recommendation. Processor 46 may analyze the data and may generate the vehicle operation energy efficiency recommendation based on at least one of vehicle sensor data 34, road data 36, driving style data 38, vehicle data 40, vehicle location 42 and vehicle maintenance schedule 44. Transmitter 72 may send the energy efficiency recommendation to receiver 22 via communications network 18.

Vehicle sensor data 34 may be stored in server 16 directly or indirectly. For example, vehicle 14 may collect vehicle sensor data 34 and may send the collected vehicle sensor data 34 to server 16 for storage. In this way, if device 12 gets stolen or needs to be replaced, the data stored in device 12 will not be lost, as the data has been backed up in server 16. In another exemplary embodiment, vehicle sensor data 34 may be stored in an on board vehicle computer. Additionally, road data 36, driving style data 38, vehicle data 40, vehicle location 42 and vehicle maintenance schedule 44 may also be stored in either server 16 on in an on board vehicle computer.

In another exemplary embodiment, device 12 may generate a vehicle operation energy efficiency recommendation. Processor 28 may generate a vehicle operation energy efficiency recommendation by querying vehicle information database 13. Vehicle information database 13 may be stored in memory 26 of device 12. Processor 28 may query vehicle information database 13 to retrieve vehicle sensor data 34 for use in generating a vehicle operation energy efficiency recommendation. Processor 28 may also query vehicle information database 13 for at least one of road data 36, driving style data 38, vehicle data 40, vehicle location 42 and vehicle maintenance schedule data 44. Alternatively, device 12 may receive from server 16 or an on board vehicle computer (not shown) at least one of vehicle sensor data 34, road data 36, driving style data 38, vehicle data 40, vehicle location 42 and vehicle maintenance schedule data 44. Processor 28 may analyze the data and generate a vehicle operation energy efficiency recommendation based at least in part on the analyzed data. Vehicle information database 13 may be located in memory 26 of device 12 or may be in memory 56 of server 16. If vehicle information database 13 is in memory 56 of server 16, processor 28 may communicate with server 16 via communications network 18.

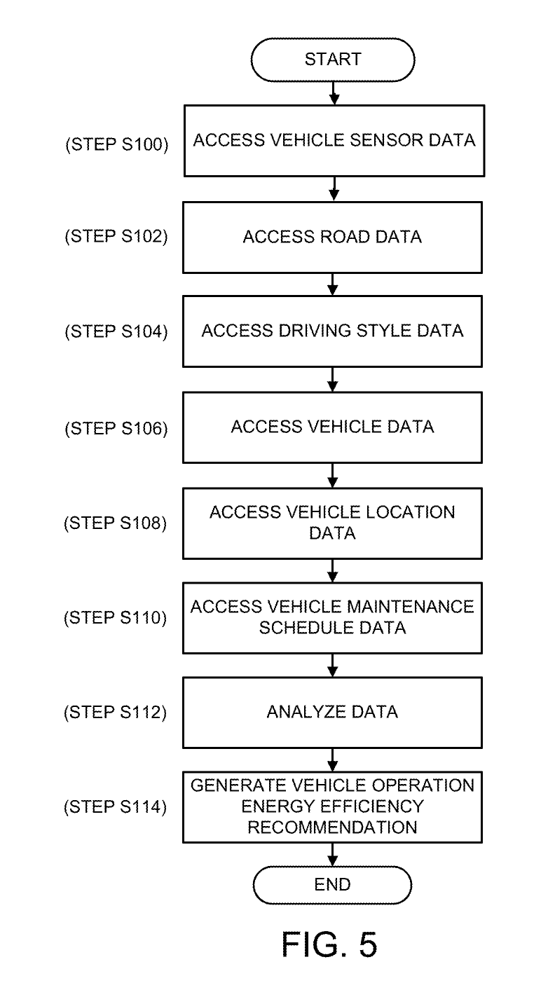

FIG. 5 is a flow chart of an exemplary process for generating a vehicle operation energy efficiency recommendation, in accordance with the principles of the present invention. Vehicle sensor data is accessed (Step S100). Methods for generally accessing vehicle sensor data are known and are beyond the scope of this invention. Road data 36 is accessed (Step S102). Driving style data 38 is accessed (Step S104). Vehicle data 40 is accessed (Step S106). Vehicle location data 42 is accessed (Step S108). Vehicle maintenance schedule data 44 is accessed (Step S110). The accessed data is analyzed (Step S112). A vehicle operation energy efficiency recommendation is generated based at least in part on the analyzed data (Step S114). It is also contemplated that the energy efficiency recommendation can be based on additional criteria such as shortest travel time with highest energy efficiency, highest energy efficiency with least elapsed distance, or other multiple factors. The determination as to which method to use to determine the energy efficiency recommendation can be user selectable.

In an alternate embodiment, the user may be presented with a list of multiple vehicle operation energy efficiency recommendations and offered the opportunity to select one vehicle operation energy efficiency recommendation. The multiple vehicle operation energy efficiency recommendations can be presented visually and/or audibly, with the user's selection being captured by selecting an area on the display 32 or via input device 24, or captured through voice recognition. The vehicle operation energy efficiency recommendations can be ordered from most to least efficient, or vice versa. It is contemplated that the user can override this feature, thereby allowing the device 12 to order the energy efficiency recommendations. Although Steps S100 through S110 are shown in FIG. 5 in a particular order, the invention is not limited to, such. Only one or more of Steps S100-S110 need to be considered and the steps do not need to be executed in the order shown.

In one embodiment, the user is presented with a list of suggested energy efficiency recommendations. Device 12 may calculate an improvement in the energy efficiency of the vehicle after implementation of the energy efficiency recommendation, and may display information associated with the improvement in the energy efficiency of the vehicle. The vehicle operation energy efficiency recommendation may include a list of recommended vehicle adjustments. The energy efficiency recommendation may be sent or displayed at a wireless mobile device, a computer, a vehicle device, a vehicle display system or a separate display within or connected to vehicle 14, among others. The energy efficiency recommendation may be printed at, for example, a printer in communication with a wireless mobile device or vehicle 14. The energy efficiency recommendation may be emailed to a user who may print the energy efficiency recommendation.

Additionally, the energy recommendation may be accessible via the Internet. Server 16 may send the energy efficiency recommendation to a website and may send a driver of vehicle 14 login information associated with the website. A driver of vehicle 14 may use a username and password to log in into a website and access the energy efficiency recommendation. The driver of vehicle 14 may use a wireless mobile device, a computer, etc. to login to the website.

The present invention can be realized in hardware or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program, software or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to, what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for providing vehicle operation energy efficiency recommendation for a vehicle, the method comprising:
accessing vehicle sensor data;
analyzing the accessed vehicle sensor data; and
generating the vehicle operation energy efficiency recommendation, the vehicle operation energy efficiency recommendation based in part on the analyzed vehicle sensor data.

2. The method of claim 1, wherein the vehicle sensor data includes at least one of vehicle emissions data, engine performance data and vehicle fluid data.

3. The method of claim 1, further comprising:
accessing driving style data corresponding to a driver of the vehicle; wherein generating the vehicle operation energy efficiency recommendation is further based at least in part on the driving style data.

4. The method of claim 1, further comprising:
calculating an improvement in an energy efficiency of the vehicle after implementation of the vehicle operation energy efficiency recommendation; and
displaying information associated with the improvement in the energy efficiency of the vehicle.

5. The method of claim 1, further comprising:
sending the vehicle operation energy efficiency recommendation to at least one of a wireless mobile device and a vehicle device.

6. The method of claim 1, further comprising:
displaying the vehicle operation energy efficiency recommendation at one of a wireless mobile device and a vehicle device.

7. The method of claim 1, wherein the vehicle operation energy efficiency recommendation includes a list of recommended vehicle adjustments.

8. The method of claim 1, further comprising:
accessing at least one of terrain information and traffic congestion information; and
generating the vehicle operation efficiency recommendation based at least in part on at least one of terrain information and traffic congestion information.

9. The method of claim 1, further comprising:
accessing weather information; and
generating the vehicle operation efficiency recommendation based at least in part on the weather information.

10. A system, comprising:
a device, the device including a processor, the processor:
accessing vehicle sensor data;
analyzing the accessed vehicle sensor data; and
providing a vehicle operation energy efficiency recommendation, the vehicle operation energy efficiency recommendation based in part on the analyzed vehicle sensor data.

11. The system of claim 10, wherein the vehicle sensor data includes at least one of vehicle emissions data, engine performance data and vehicle fluid data.

12. The system of claim 10, the processor further:
accessing driving style data corresponding to a driver of a vehicle; and where generating the vehicle operation energy efficiency recommendation is further based at least in part on the driving style data.

13. The system of claim 10, the processor further:
calculating an improvement in an energy efficiency of a vehicle after implementation of the vehicle operation energy efficiency recommendation; and
displaying information associated with the improvement in the energy efficiency of the vehicle.

14. The system of claim 10, the device further comprising a transmitter, the transmitter sending the vehicle operation energy efficiency recommendation to at least one of a wireless mobile device and a vehicle device.

15. The system of claim 10, the processor further causing the vehicle operation energy efficiency recommendation to be displayed at one of a wireless mobile device and a vehicle device.

16. The system of claim 10, wherein the vehicle operation energy efficiency recommendation includes a list of recommended vehicle adjustments.

17. The system of claim 10, the processor further:
generating the vehicle operation energy efficiency recommendation based at least in part on the vehicle sensor data.

18. The system of claim 10, the processor further:
accessing weather information; and
generating the vehicle operation efficiency recommendation based at least in part on the weather information.

19. The system of claim 10, further comprising:
a server in communication with the device, the server comprising:
a memory, the memory storing vehicle sensor data;
a server processor, the server processor accessing the vehicle sensor data and generating a vehicle operation energy efficiency recommendation based at least in part on the vehicle sensor data; and
a server transmitter, the server transmitter transmitting the vehicle operation energy efficiency recommendation to the device.

20. A computer readable medium storing computer readable instructions that when executed by a processor, cause the processor to perform a method comprising:
accessing vehicle sensor data;
analyzing the vehicle sensor data; and
generating a vehicle operation energy efficiency recommendation, the vehicle operation energy efficiency recommendation based in part on the analyzed vehicle sensor data.

21. The computer readable medium of claim 20, wherein the vehicle sensor data includes at least one of vehicle emissions data, engine performance data and vehicle fluid data.

22. The computer readable medium of claim 20, the method further comprising:
accessing driving style data corresponding to a driver of a vehicle; and
generating the vehicle operation energy efficiency recommendation based at least in part on the driving style data.

23. The computer readable medium of claim 20, the method further comprising:
calculating an improvement in an energy efficiency of a vehicle after implementation of the vehicle operation energy efficiency recommendation; and
displaying information associated with the improvement in the energy efficiency of the vehicle.

24. The computer readable medium of claim 20, the method further comprising:
sending the vehicle operation energy efficiency recommendation to at least one of a wireless mobile device and a vehicle device.

25. The computer readable medium of claim 20, the method further comprising:
displaying the energy efficiency recommendation at one of a wireless mobile device and a vehicle device.

26. The computer readable medium of claim 20, the method further comprising:
accessing weather information; and
generating the vehicle operation energy efficiency recommendation based at least in part on the weather information.
